(19) United States
(12) Patent Application Publication
(10) Pub. No.: US 2008/0245508 A1
(43) Pub. Date: Oct. 9, 2008

(54) Assembly of linear motor cooling parts

(75) Inventors: Yoshifumi Shimura, Minamitsuru-gun (JP); Masami Kimijima, Minamitsuru-gun (JP)

Correspondence Address: DRINKER BIDDLE & REATH (DC), 1500 K STREET, N.W., SUITE 1100, WASHINGTON, DC, 20005-1209, US

(73) Assignee: FANUC LTD

(21) Appl. No.: 12/076,049

(22) Filed: Mar. 13, 2008

(30) Foreign Application Priority Data
Apr. 5, 2007 (JP) 2007-099183

(51) Int. Cl. F28D 15/00; H02K 9/00

(52) U.S. Cl. 165/104.11; 310/12; 310/16

(57) ABSTRACT

The cooling means of the linear motor is formed of an assembly of plate parts adapted to dimensions of linear motor stator element plates on which magnets are disposed, piping, and bonding material for securing the plate parts and the piping to each other. Opposite ends of the plate parts are bent to form piping housing portions. The stator element plates and the plate parts are mounted to the machine while overlaid on each other. The piping is passed through the piping housing portions at the opposite ends of the plate parts. Thus, mounting of the cooling means is completed.

### BACKGROUND OF THE INVENTION

1. Field of the Invention

The present invention relates to an assembly of linear motor cooling parts mounted to a linear motor to form a cooling means.

2. Description of the Related Art

An electric motor produces heat when supplied electric energy is converted into heat energy. A cooling means for absorbing heat and cooling the electric motor is attached to the electric motor. Employed as this cooling means in general is to form a refrigerant path (hole) through which a refrigerant such as water passes in a casing itself of the electric motor to thereby cool the electric motor. Other than forming the refrigerant path in the casing of the electric motor, mounting a cooling jacket in which a refrigerant path is disposed in a meandering manner around the electric motor to cool the electric motor is also known (see Japanese Patent Application Laid-open No. 2004-147424).

Also known is a cooling means of a linear motor carrying out linear motion, in which meandering piping is mounted to a face of a support body opposite the face on which electric action parts such as coil, a permanent magnet and an inductor of the linear motor are mounted, and a refrigerant is passed through the piping to thereby cool the linear motor (see WO 03/015242 A1).

Furthermore, also known is a linear motor in which a pipe through which refrigerant is passed is not a meandering pipe but is a straight pipe, the straight pipe is disposed on each end of a plate member made of aluminum or the like, and a plate member is mounted to the stator of a linear motor to cool the linear motor.

A first example of the prior-art cooling means for the linear motor, which is formed of a plate member and straight piping through which a refrigerant is passed, will be described by using FIGS. 9A and 9B.

In this cooling means, one plate member 10 is used as shown in FIG. 9A. In the plate member 10, mounting holes 5 for mounting a stator mounted with magnets (or exciting coils) are arranged on opposite longitudinal side portions (sides parallel to a moving direction of a moving member of the linear motor). The opposite longitudinal sides of the plate member 10 are formed by bending or the like into piping housing portions 6 for housing piping 4 through which the refrigerant is passed. To the piping housing portions 6, straight portions of the piping 4 formed of a material such as copper having high thermal conductivity are bonded with bonding material such as an epoxy adhesive having high thermal conductivity. By bending one end of the straight portions forming the piping 4, the two straight portions are connected at their bent portions.

The stator of the linear motor on which the magnets (or exciting coils) are disposed is mounted to the plate member 10. FIG. 1A shows stator element plates 1 forming the stator mounted to the plate member 10 and an arrangement of the plates 1. The stator of the linear motor is formed of a plurality of stator element plates 1. Each of the stator element plates 1 is mounted with the magnets 2 and is formed at its opposite ends with mounting holes 3 in positions corresponding to the mounting holes 5 in the plate member 10. Through the mounting holes 3 and the mounting holes 5, the stator element plates 1 shown in FIG. 1A are secured to the plate member 10 shown in FIG. 9A with bolts or the like and an assembly of the stator element plates 1 and the plate member 10 is fixed to a machine (not shown) to which the linear motor is mounted.

Next, a second example different from the first example of the prior-art cooling means for the linear motor shown in FIG. 9A will be described by using FIGS. 10A and 10B.

The cooling means is formed of two plate members 11 respectively formed with piping housing portions 6 for housing piping 4 and a plurality of mounting holes 5 and the piping 4 which is secured to the piping housing portions 6 of the plate members 11 with an adhesive or the like and through which a refrigerant is passed. Through the mounting holes 3 and the mounting holes 5, the stator element plates 1 shown in FIG. 1A are secured to the two plate members 11 shown in FIG. 10A with bolts or the like and an assembly of the stator element plates 1 and the plate members 11 is fixed to a machine (not shown) to which the linear motor is mounted.

By passing the refrigerant such as water through the piping 4 shown in FIGS. 9A and 10A, the respective stator element plates 1 forming the stator of the linear motor are cooled through the plate member 10 or the plate members 11 and the linear motor is cooled.

In the case of cooling means for cooling a linear motor, as described in WO 03/015242 A1 in which meandering piping is disposed on a face of a support body opposite the face on which electric action parts of the linear motor are mounted, the meandering piping is expensive to manufacture. Moreover, it is necessary to form the meandering piping to a special length adapted to a length of the linear motor (a length of a stroke of the moving member) according to an application of a user who operates the linear motor and therefore it is difficult to make the cooling means standard and versatile.

In the case shown in FIGS. 9A and 10A in which the cooling means of the linear motor is formed of the plate member and the piping having the straight portions to be secured to the plate member, the cooling means is formed of one or two plate members 10 or 11 and adapted to the exclusive use of the linear motor. Therefore, it is impossible to adapt the cooling means to linear motors having different lengths and different arrangements of magnet plates forming the stator according to an application of a user who operates the linear motor and it is difficult to make the cooling means standard and versatile.

### SUMMARY OF THE INVENTION

Therefore, it is an object of the present invention to provide an assembly of linear motor cooling parts having general versatility and adaptable as a cooling means to linear motors of various lengths.

According to the invention, there is provided an assembly of cooling parts for cooling a linear motor, the assembly of the cooling parts including a plurality of plate parts, piping for a refrigerant, and bonding material for bringing the plurality of plate parts and the piping for the refrigerant into close contact with each other. The plate parts respectively have dimensions adapted to dimensions of stator element plates forming a stator of the linear motor. Straight portions of the piping for the refrigerant are bonded to opposite sides of the plurality of plate parts with the bonding material to form the cooling means for cooling the linear motor.

The piping may be formed by connecting a straight pipe and a straight pipe with a bent joint pipe part.

The plate parts which are a part of the cooling parts may be fixed, together with the liner motor parts, to a machine. The plate parts may be made of metal or resin having high thermal conductivity. The piping and the bonding material may be made of metal or resin having at least thermal conductivity.

With the invention, the plate parts are formed according to the dimensions of the stator element plates of the linear motor. Therefore, it is possible to easily manufacture the cooling means of the linear motor by preparing the plate parts according to the number and kinds of the stator element plates of the linear motor and by mounting and securing to the plate parts the piping through which the refrigerant is passed. Moreover, the cooling means can be easily mounted when mounting the linear motor to the machine, thus having general versatility irrespective of the length of the linear motor.

### BRIEF DESCRIPTION OF THE DRAWINGS

The above and other objects and features of the present invention will become apparent from the following description of the embodiment with reference to the accompanying drawings, wherein:

FIG. 1A is a plan view of a stator of a linear motor cooled by a linear motor cooling means;

FIG. 1B is a right side view of the stator of the linear motor shown in FIG. 1A;

FIG. 2A is a plan view of plate parts forming the linear motor cooling means according to the invention;

FIG. 2B is a side view of the plate part in FIG. 2A;

FIG. 2C is a schematic diagram of piping for a refrigerant forming the linear motor cooling means according to the invention;

FIG. 3A is a plan view for explaining a process of assembly of plate members, the piping, and bonding material into the linear motor cooling means according to the invention;

FIG. 3B is a sectional view taken along a line A-A in FIG. 3A;

FIG. 4A is a plan view for explaining a state after the assembly of the plate members, the piping, and the bonding material into the linear motor cooling means according to the invention;

FIG. 4B is a sectional view taken along a line A-A in FIG. 4A;

FIG. 5A shows an example of the piping forming the linear motor cooling means according to the invention;

FIG. 5B shows an example different from the piping in FIG. 5A;

FIG. 6A is a drawing showing forming of piping housing portions in different forms from piping housing portions shown in FIGS. 2A and 2B on the plate member;

FIG. 6B is a drawing showing forming of piping housing portions in different forms from those shown in FIG. 6A on the plate member;

FIG. 6C is a drawing showing forming of piping housing portions in different forms from those shown in FIGS. 6A and 6B on the plate member;

FIG. 7A is a drawing showing a case where the linear motor cooling means is assembled by using the plate members having the piping housing portions shown in FIG. 6C;

FIG. 7B is a sectional view taken along a line A-A in FIG. 7A;

FIG. 8A is a drawing showing a case where the piping is coupled to the plate members shown in FIG. 6A;

FIG. 8B is a drawing showing a case where the piping is coupled to the piping housing portions of the plate parts shown in FIGS. 2A and 2B;

FIG. 9A is a plan view of a first example of a prior-art linear motor cooling means;

FIG. 9B is a sectional view taken along a line A-A of the cooling means in FIG. 9A;

FIG. 10A is a plan view of a second example of the prior-art linear motor cooling means; and

FIG. 10B is a sectional view taken along a line A-A of the cooling means in FIG. 10A.

### DETAILED DESCRIPTION OF THE PREFERRED EMBODIMENTS

First, a stator of a linear motor to be cooled by a cooling means according to the present invention will be described by using FIGS. 1A and 1B.

The stator of the linear motor is formed of a plurality of stator element plates 1. Magnets or exciting coils are disposed on the stator element plates 1. In the example shown in FIGS. 1A and 1B, a plurality of magnets 2 are arranged on each of the stator element plates 1 along a moving direction of a linear motor moving member. By arranging the plurality of stator element plates 1 along the moving direction of the moving member of the linear motor, the stator of the linear motor is formed.

As the stator element plates 1, two kinds of plates, i.e., plates of standard length (dimension in the moving direction of the linear motor moving member) and plates of shorter length are prepared. According to a length of the linear motor to be formed, the stator is formed by using a plurality of stator element plates 1 of the standard length and the stator element plate 1 of the shorter length (specific length). As the stator element plates 1 of the length shorter than the standard length, it is preferable to prepare the plates of various lengths from the shortest plate to the longest plate (of a length close to the standard length) as required.

In the example shown in FIG. 1A, the stator is formed of three stator element plates 1 of the standard length and one short stator element plate 1. Each of the stator element plates 1 is formed at its opposite side ends (sides parallel to the moving direction of the moving member of the linear motor) with a plurality of mounting holes 3.

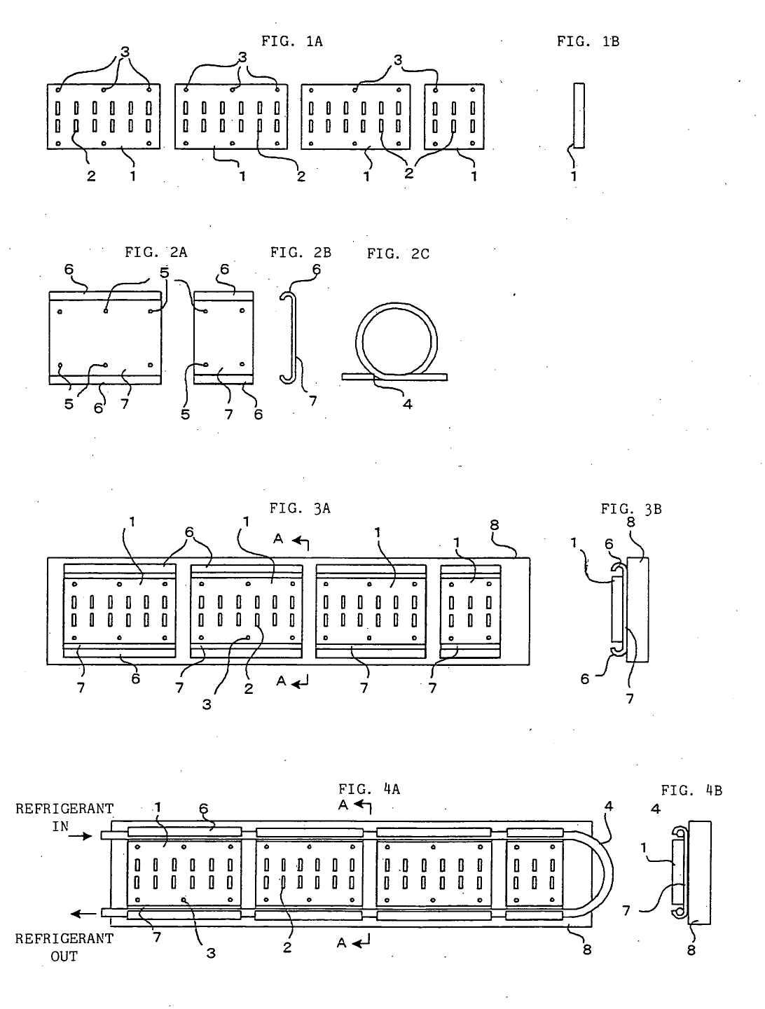

Next, an assembly structure of linear motor cooling parts forming the cooling means of the present invention, used for the above-described linear motor, will be described by using FIGS. 2A to 2C.

The linear motor cooling parts forming the cooling means of the linear motor include plate parts 7 (FIGS. 2A and 2B) cut to the same lengths as the lengths (dimensions in the moving direction of the linear motor moving member) of stator element plates 1 of the linear motor, piping 4 (FIG. 2C) through which a refrigerant such as water is passed, and bonding material (not shown) for bonding and fixing the piping 4 to the plate parts 7.

Opposite side ends (sides parallel to the moving direction of the moving member of the linear motor) of the plate parts 7 bend inward to form piping housing portions 6 for housing the piping 4 through which the refrigerant is passed. In the piping housing portions 6, straight portions of the piping 4 through which the refrigerant is passed are housed and bonded to the piping housing portions 6 with the bonding material. Each of the plate parts 7 is formed with mounting holes 5 in positions corresponding to the mounting holes 3 formed in the corresponding stator element plate 1 of the linear motor.

For the plate parts 7, metal such as aluminum, copper, and iron or resin (e.g., “EC-1010” manufactured by Tohto Kasei Co., Ltd.) such as epoxy resin having high thermal conductivity is used. If the plate parts 7 are made of metal material, the piping housing portions 6 can be formed at the opposite side ends by bending or cutting. Alternatively, the plate parts 7 having the piping housing portions 6 may be molded integrally by aluminum die casting or magnesium die casting. On the other hand, if the material of the plate parts 7 is resin, the plate parts 7 having the piping housing portions 6 can be integrally molded by extrusion molding, injection molding, or the like.

The piping 4 shown in FIG. 2C is made of resin that has thermal conductivity and can be bent. As the bonding material for securing the piping 4 to the plate parts 7, an epoxy adhesive, silicon sheet, prepreg, or the like is used.

Assembly of the above-described plurality of plate parts 7, piping 4 and bonding material into cooling means will be described by using FIGS. 3A, 3B, 4A, and 4B.

The certain number of stator element plates 1 of the standard length and a stator element plate 1 of a specific shorter length, which form the stator of the linear motor, are prepared. By inserting bolts (not shown) through the mounting holes 3 in the stator element plates 1 and the corresponding mounting holes 5 in the plate parts 7, the plate parts 7 and the stator element plates 1 are mounted to a machine 8 while overlaid on each other as shown in FIG. 3B.

In an example shown in FIG. 3A, three stator element plates 1 of the standard length and one stator element plate 1 of the specific shorter length are arranged in a row to thereby form the stator of the linear motor. The same kinds and the same numbers of plate parts 7 corresponding to the above kinds (lengths) and numbers of stator element plates 1 (i.e., three plate parts 7 of the standard length and one plate part 7 of the specific shorter length) are prepared and the respective stator element plates 1 are mounted to the machine 8 while overlaid on the corresponding plate parts 7.

Next, one piping 4 is disposed in the piping housing portions 6 of the plate parts 7 shown in FIGS. 3A and 3B as shown in FIGS. 4A and 4B and the disposed piping 4 is secured to the plate parts 7 with the bonding material. Thus, mounting and assembly of the cooling means to the linear motor are completed.

In the above-described embodiment, the material of the piping 4 is flexible resin. The piping 4 is formed of the two straight portions respectively housed in the piping housing portions 6 formed at the opposite side ends of the plate parts 7 and a bent portion (see FIG. 4A) connecting the straight portions. The bent portion can easily be formed by bending the piping 4 made of resin. However, even if the piping 4 is made of material having little flexibility (e.g., metal material), the bent portion can be formed easily. This will be described below.

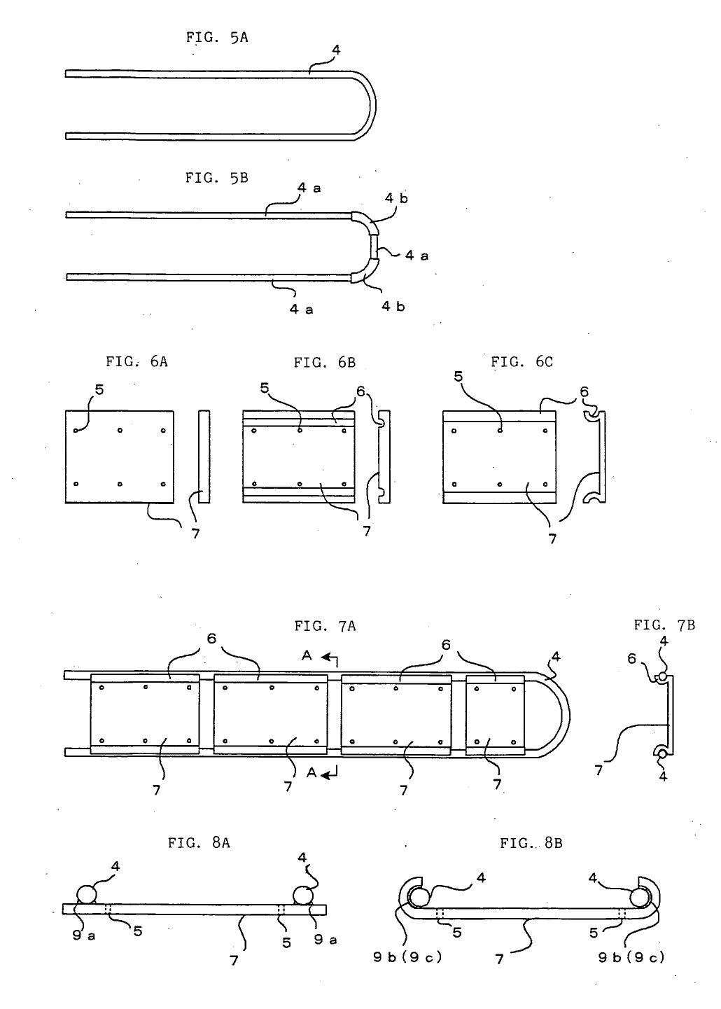

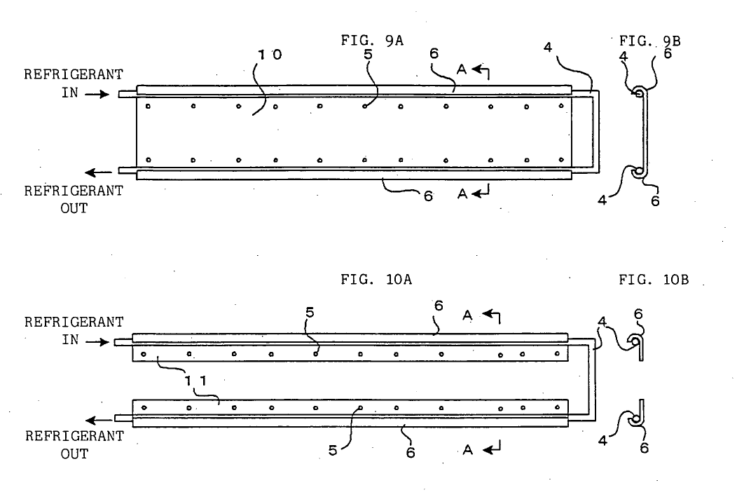

FIGS. 5A and 5B are drawings showing examples of working of the piping when the piping to be disposed in the piping housing portions 6 of the plate parts 7 shown in FIGS. 3A and 3B is made of metal or resin having little flexibility.

The first example of the piping 4 shown in FIG. 5A is one formed by bending a long straight piping 4 into a U shape at a central portion in a longitudinal direction to thereby integrally form two straight portions to be housed in the piping housing portions 6 formed at the opposite side ends of the plate parts 7 and a bent portion connecting the straight portions.

The second example of the piping 4 shown in FIG. 5B is one formed by coupling two long straight piping 4a with a bent portion formed by respectively connecting bent joint pipe parts 4b to opposite ends of a short straight piping 4a.

In the above embodiment, the piping housing portions 6 for housing the piping 4 through which the refrigerant is passed are formed by bending the opposite side ends of the plate parts 7 inward as shown in FIGS. 2B and 3B. However, the piping housing portions 6 maybe also formed (worked) in other ways. Therefore, examples of forming of the piping housing portions 6 will be described below with reference to FIGS. 6A to 6C.

In the example shown in FIG. 6A, the plate part 7 is not especially worked to form the piping housing portions 6 but is only provided with areas where the piping is to be secured at side portions (side portions outside the mounting holes 5) of the plate part 7.

In the example shown in FIG. 6B, grooves extending parallel to the side portions (side portions outside the mounting holes 5) of the plate part 7 are formed at the side portions and are used as the piping housing portions 6.

The example shown in FIG. 6C is the same as the examples shown in FIGS. 2B and 3B in that the opposite side ends (sides parallel to the moving direction of the moving member of the linear motor) of the plate parts 7 are bent to form the piping housing portions 6 for housing the piping 4 through which the refrigerant is passed. However, the piping housing portions 6 shown in FIGS. 2B and 3B have recessed spaces open inward (toward the centers of the plate parts) while the piping housing portions 6 in the example shown in FIG. 6C have recessed spaces open outward.

FIGS. 7A and 7B show a state in which the cooling means is assembled by using the plate parts 7 having the piping housing portions 6 in the forms shown in FIG. 6C.

Here, examples of a method of securing the piping housed in the piping housing portions 6 of the plate parts 7 to the plate parts 7 will be described by using FIGS. 8A and 8B.

FIG. 8A shows the method of securing the piping 4 housed in the piping housing portions 6 shown in FIG. 6A (the plate parts 7 are not especially worked and partial areas of the plate parts 7 are simply used as the piping housing portions 6) to the plate parts 7. The straight portions of the piping 4 are disposed in the areas of the plate parts 7 outside the mounting holes 5 and clearances between the piping 4 and the plate parts 7 are filled with epoxy resin adhesive 9a to secure the piping 4 to the plate parts 7.

FIG. 8B shows the method of securing the piping 4 housed in the piping housing portions 6 (the recessed spaces in the piping housing portions 6) shown in FIGS. 2B and 3B to the plate parts 7. Clearances between the piping 4 and the plate parts 7 at the piping housing portions 6 are filled with bonding material such as silicone sheets 9b, prepreg 9c, and epoxy resin adhesive 9a to secure the piping 4 to the plate parts 7. This securing method can be also applied to securing the piping 4 housed in the piping housing portions 6 (the recessed spaces in the piping housing portions 6) shown in FIG. 6B or 6C to the plate parts 7.

If the material of the piping 4 is resin and the bonding material for securing the piping 4 to the plate parts 7 is made of resin, it is preferable to use resin having thermal conductivity and also flexibility and heat resistance. Because the linear motor is mounted in a machine tool or the like in many cases, it is preferable to use resin material proof against sprinkling of metal dust and splashes of cutting fluid.

As described above, according to the invention, the assembly of the cooling parts for cooling the liner motor is formed of a plurality of plate parts adapted to dimensions of the stator element plates of the linear motor, the piping through which the refrigerant is passed, and the bonding material for bringing the plurality of plate parts and the piping into close contact with each other. Therefore, in mounting the linear motor to the machine, it is possible to easily install the linear motor having the cooling means in the machine by using the assembly of the linear motor cooling parts. Moreover, it is possible to easily form the cooling means adapted to the linear motor of any length irrespective of the length of the stroke of the linear motor and therefore the assembly has general versatility.

1. An assembly of cooling parts for cooling a linear motor, wherein:
said cooling parts includes a plurality of plate parts, piping through which a refrigerant is passed, and bonding material for bringing the plurality of plate parts and the piping into close contact with each other;
said plurality of plate parts respectively have dimensions corresponding to dimensions of stator element plates forming a stator of the linear motor; and
straight portions of said piping are bonded to opposite sides of the respective plate parts with the bonding material to form cooling means for cooling the linear motor.

2. The assembly of linear motor cooling parts according to claim 1, wherein said piping is formed of the first straight portion to be bonded to the one sides of the plate parts, the second straight portion to be bonded to the other sides of the plate parts, and a bent portion connecting the first and second straight portions, which are united in a body.

3. The assembly of linear motor cooling parts according to claim 1, wherein the piping is formed of the first straight portion to be bonded to the one sides of the plate parts, the second straight portion to be bonded to the other sides of the plate parts, and a bent portion which includes a joint pipe part and connects the first and second straight portions.

4. The assembly of linear motor cooling parts according to claim 1, wherein the straight portions of the piping are housed in piping housing portions formed by respectively bending opposite side ends of the plate parts.

5. The assembly of linear motor cooling parts according to claim 1, wherein grooves extending parallel to opposite side portions of the plate parts are formed at the side portions and the straight portions of the piping are housed in the grooves.

6. The assembly of linear motor cooling parts according to claim 1, wherein the plate parts of the cooling parts are fixed, together with the liner motor cooling parts, to a machine.

7. The assembly of linear motor cooling parts according to claim 1, wherein the plate parts are made of metal or resin material having high thermal conductivity.

8. The assembly of linear motor cooling parts according to claim 1, wherein the piping and the bonding material are made of metal or resin having at least thermal conductivity.
